(19) United States
(12) Patent Application Publication
(10) Pub. No.: US 2010/0254148 A1
(43) Pub. Date: Oct. 7, 2010

(54) Lamp holder structure having heat dissipation fins

(75) Inventors: Chien-Chung Huang, Taichung (TW); Yen-Wei Ho, Taichung (TW)

Correspondence Address: Genius Electronic Optical Co., Ltd., P.O. Box 215, TAICHUNG, 40099, TW

(73) Assignee: Genius Electronic Optical Co., Ltd.

(21) Appl. No.: 12/461,032

(22) Filed: Jul. 30, 2009

(30) Foreign Application Priority Data
Apr. 3, 2009 (TW) 098205448

(51) Int. Cl. F21V 29/00

(52) U.S. Cl. 362/373

(57) ABSTRACT

A lamp holder structure having heat dissipation fins comprises a base having a recess with threaded holes for install a luminous lamp set and at least one power line-in for connecting a power line. A plurality of heat dissipation fins arranged in parallel is extended and integrated from a corresponding exterior of the recess and a plurality of heat dissipation diverging fins is extended and integrated from an extreme exterior of the heat dissipation fins. Symmetric protruding plates are connected to predetermined places of the exterior of the base to pivotally connect a positioning plate capable of adjusting angles. A light-transmissive plate further seals the base and symmetric side strips are used to respectively lock symmetric frame borders of the base to position the light-transmissive plate. The corresponding sides of the recess of the base have locking holes for locking symmetric side covers.

### FIELD OF THE INVENTION

The present invention relates to a lamp holder structure having heat dissipation fins, and more particularly to the lamp holder structure having heat dissipation fins so that a LED (light emitting diode) lamp set can be directly installed in the lamp holder to rapidly conduct heat energy generated by the LED lamp set through the plurality of heat dissipation fins disposed to the lamp holder and the length of the lamp holder can be cut upon demands to provide advertising projection.

### BACKGROUND OF THE INVENTION

According to a conventional projection lamp structure, an end of a metal base body has a circuit through hole where an external portion forms a plurality of heat dissipation fins and an accommodating space is formed from the rear to accommodate a driving circuit board so that persons may conveniently check and maintain it. A metal panel is fastened and disposed to the front of the metal base body, and has LEDs (light emitting diode) with high power disposed thereon, and includes through holes passed by circuits. The metal panel can provide disposing and switching different light sources. A reflective protection body is respectively disposed to two reflection masks that are disposed to the front of LEDs to enhance the reflection of the light source and to prevent the circuits from being exposed. A metal cover is further fastened and disposed to the rear of the metal base body to seal the accommodating space of the metal base body so as to form a high-power projection lamp.

Although the metal base body of the projection lamp structure has the plurality of heat dissipation fins provided for rapidly dissipating heat energy generated by the LEDs, the front of the structure has an inner concave sealing notch. Therefore, the specification of the metal base body can be reasonably estimated as a fixed size. In another word, the length cannot be decided according to the width demand of a signboard.

Moreover, the shape design of the metal base body must indirectly transfer the heat energy of the LEDs through the metal panel, resulting in reducing the heat conduction function.

Accordingly, to overcome the foregoing shortcoming, the inventor(s) of the present invention based on years of experience in the related field to conduct extensive researches and experiments for the metal base body of the conventional structure, and finally invented a lamp holder structure having heat dissipation fins.

### SUMMARY OF THE INVENTION

A primary objective of the present invention is to provide a lamp holder structure having heat dissipation fins of which its length can be cut upon real demands and provided for directly installing and fastening a LED (light emitting diode) luminous lamp set.

To achieve the foregoing objective, the lamp holder having heat dissipation fins of the present invention comprises a long strip base. An end of the base has a recess showing passing through state along a long side. A corresponding surface of the recess comprises several threaded holes for installing a light emitting lamp set. The foregoing corresponding surface has at least one power line-in for connecting a power line. A plurality of heat dissipation fins, which is arranged in parallel, is integrated and extended from a corresponding external surface of the recess. A portion of the heat dissipation fins includes a plurality of heat dissipation diverging fins that is integrated and extended. Two corresponding short sides of the base have a plurality of locking holes for locking symmetric side covers so that the length of forming the lamp holder can be cut upon real demands to achieve the effect of directly installing and fastening the LED luminous lamp set.

Moreover, the lamp holder of the present invention further comprises two symmetric protruding plates, a positioning plate, two side covers, a light-transmissive plate and two side strips. The two symmetric protruding plates are connected to the corresponding external surface of the base. The protruding plate includes an axle hole and a limiting hole respectively to incorporate with a locking member set for adjusting the positioning plate at multiple angles. The positioning plate has symmetric side plates. The symmetric side plates have alignment shaft holes corresponding to the axle holes of the protruding plates. Further, the positioning plate has a plurality of connecting holes for connecting an advertisement board or a board/wall to be illuminated. The two side covers have a plurality of through holes corresponding to the plurality of locking holes disposed to the short sides of the base in order to incorporate with screws. The light-transmissive plate can seal the recess of the base. The side strips are locked and connected to frame borders of the recess by incorporating with a plurality of screws, and can press the light-transmissive plate.

In addition, water stop strips are disposed between the light-transmissive plate and the two frame borders of the base. The water stop strip is accommodated in a channel preset along the frame border. Besides, water stop covers are disposed between the side covers and the two short sides of the recess of the base. The water stop cover can completely seal the short side of the recess. Accordingly, the inside of the recess of the base can form a complete enclosed space to provide a function of preventing water drops or moisture from permeating.

### BRIEF DESCRIPTION OF THE DRAWINGS

FIG. 1 is a decomposition drawing illustrating a structure according to a preferred embodiment of the present invention;

FIG. 2 is a side view illustrating a base of the structure according to a preferred embodiment of the present invention;

FIG. 3 is an assembly drawing illustrating the structure according to a preferred embodiment of the present invention;

FIG. 4 is an A-A cross-sectional drawing illustrating the structure according to a preferred embodiment of the present invention;

FIG. 5 is a top view illustrating the structure according to a preferred embodiment of the present invention;

FIG. 6 is a B-B cross-sectional drawing illustrating the structure according to a preferred embodiment of the present invention; and

FIG. 7 is a side view schematic drawing illustrating angle adjustment for the structure according to a preferred embodiment of the present invention.

### DETAILED DESCRIPTION OF THE PREFERRED EMBODIMENTS

Other features and advantages of the present invention will become apparent from the following description of the invention which refers to the accompanying drawings.

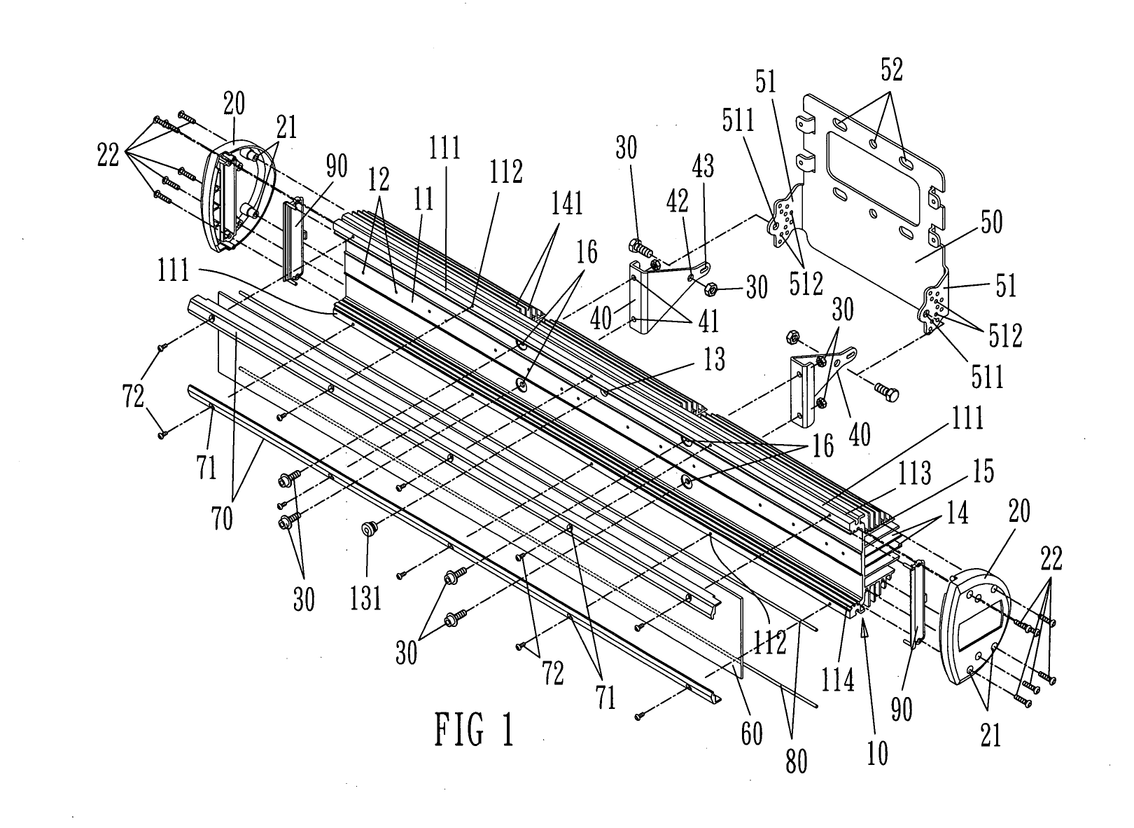

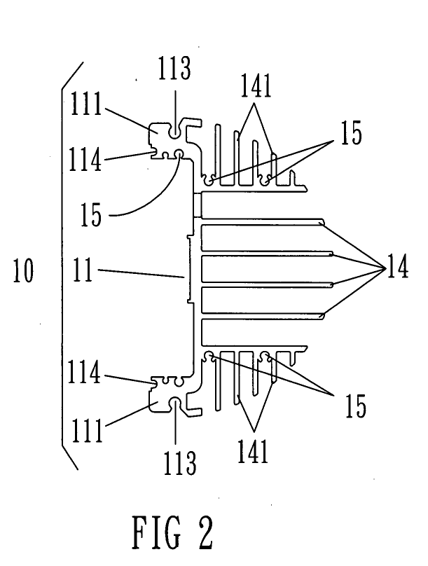

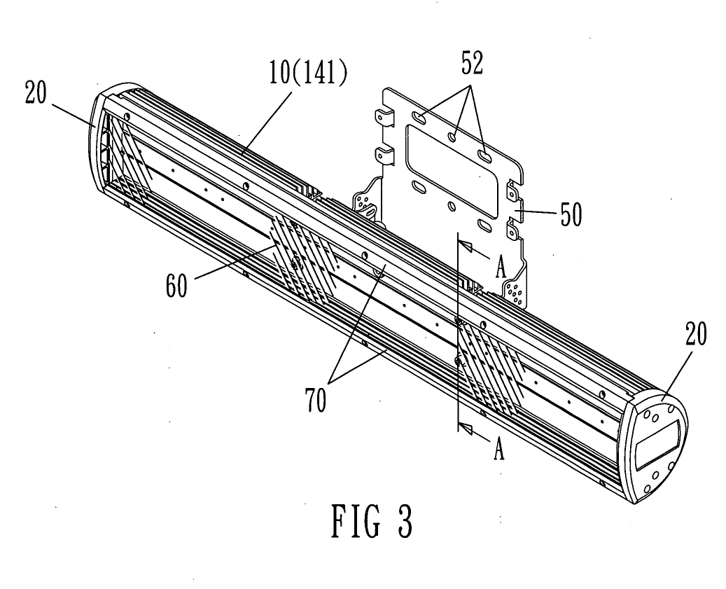

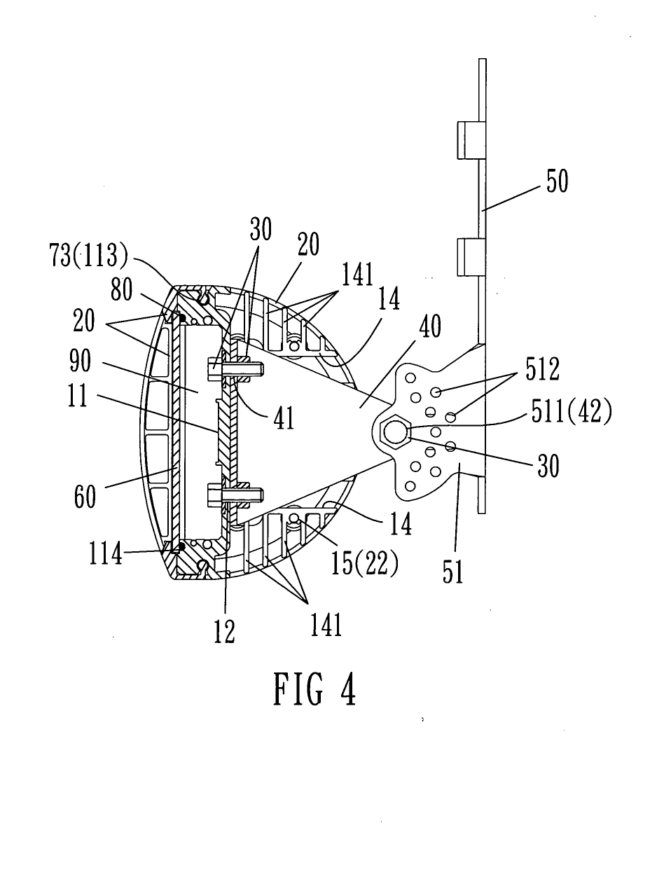

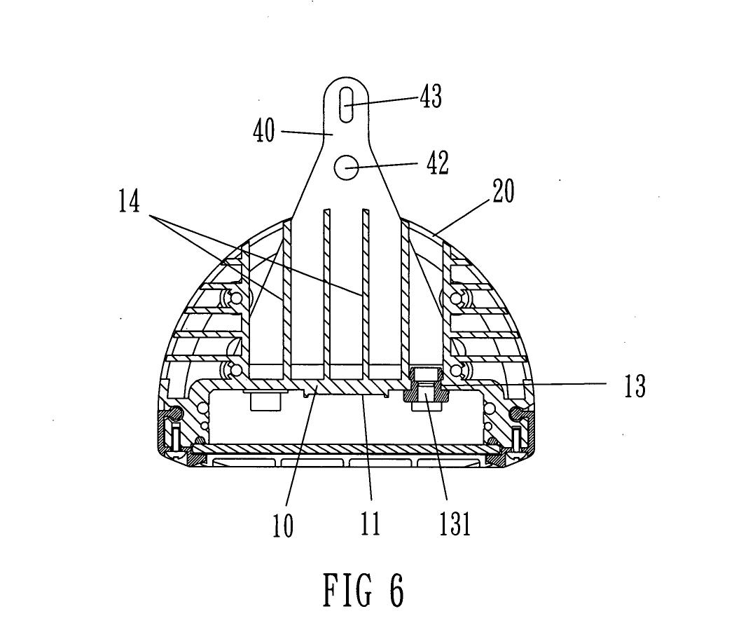

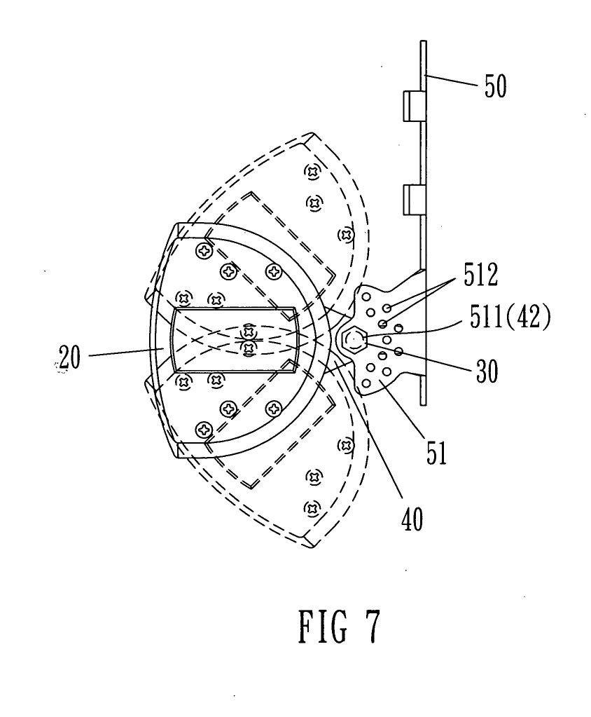

First, please refer to FIG. 1 to FIG. 7, a lamp holder structure having heat dissipation fins is shown according to a preferred embodiment of the present invention, and mainly comprises a long strip base 10, wherein an end of the base 10 has a recess 11 shown pass through state along a long side to enable the recess to form symmetric frame borders 111 along the long side. The corresponding surface of the opening of the recess 11 has a plurality of threaded holes 12 for installing a light emitting lamp set (it is not shown in the figure since it is not an emphasis of the present invention). The corresponding surface has at least one power line-in 13 for connecting a power line (not shown in the figure). The power line at the exterior of the base is connected to a waterproof connector for rapidly replacing the power line while the power line is damaged. Further, the power line-in 13 is fit with a soft water stop ring 131 (as shown in FIG. 6).

A plurality of heat dissipation fins 14 arranged in parallel is extended and integrated from the corresponding external surface of the recess 11. A plurality of heat dissipation diverging fins 141 is further extended and integrated from the extreme exterior of the heat dissipation fins. 14 to achieve the effect of increasing heat dissipation. Two short sides of the base 10 has a plurality of locking holes 15 and a portion of the locking holes 15 is distributed to the heat dissipations 14 to lock symmetric side covers 20 so that the length of forming the base can be cut upon real demands and a LED luminous lamp set can be directly installed and fastened.

It should be noted that the base 10 of the present invention is an aluminum extrusion base made of a heat conduction material. Therefore, the base 10 is not limited by the length, and can be flexibly cut.

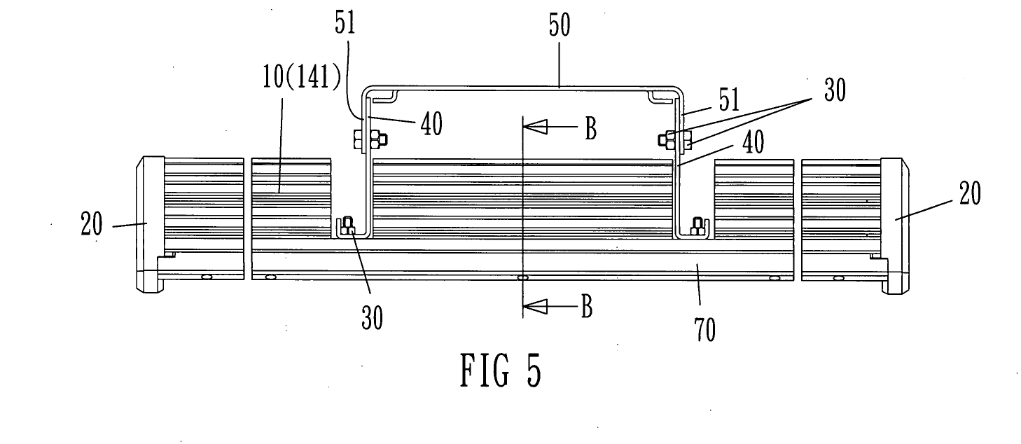

The base 10 has symmetric circular holes 16 spaced at an interval of the recess 11. As shown in FIG. 5, grooves corresponding to the circular holes 16 of the recess 11 can be cut and formed from a portion of the heat dissipation fins 14 in order to connect symmetric protruding plates 40. The symmetric protruding plates 40 are connected by a plurality of locking member sets 30. An end of the protruding plate 40 has symmetric through holes 41 for aligning the plurality of circular holes 16 of the recess 11. Another end of the protruding plate 40 has an axle hole 42 and a limiting hole 43 respectively to connect a positioning plate 50 capable of adjusting different angles by incorporating with the locking member sets 30. The positioning plate 50 mainly has symmetric side plates 51 and the symmetric side plate 51 has alignment shaft holes 511 for corresponding to the axle holes 42 of the protruding plates 40. A plurality of limited holes 512 is distributed to a periphery of the alignment shaft holes 511 of the side plates 51, and corresponds to the limiting holes 43 of the protruding plates 40. In addition, the positioning plate 50 has a plurality of connecting holes 52 for locking and combining an advertisement board or a board/wall to be illuminated (not shown in the figure).

Moreover, the lamp holder structure having the heat dissipation fins of the present invention further comprises two side covers 20, a light-transmissive palate 60 and two side strips 70 except the components such as the base 10, the two protruding plates 40 and the two side strips 50.

The two side covers 20 have a plurality of through holes 21 corresponding to the plurality of locking holes 15 at the short sides of the base 10 to incorporate with screws 22 for locking and connecting.

The light-transmissive plate 60 can seal the recess 11 of the base 10. Two long sides of the light-transmissive plate corresponding to end surfaces of the recess 11 can lean against the two frame borders 111 of the recess 11.

The side strip 70 has a plurality of locking holes 71 for locking a plurality of connecting holes 112 preset to the frame borders 111 of the recess 11 by incorporating with a plurality of screws 72, and0 can closely press the light-transmissive plate 60.

In order to obtain absolute positioning function after the side strips 70 are connected to the base 10, corresponding exteriors of the two frame borders 111 of the base 10 have symmetric fastening notches 113. Fastening portions 73 capable of providing alignment are integrated and extended from corresponding sides of the side strips 70 corresponding to the fastening notches 113 to increase the rigidity of assembling two components.

Moreover, in order to achieve the sealing effect for the recess 11 of the base 10, the present invention disposes water stop strips 80 between the two frame borders 111 of the base 10 and the light-transmissive plate 60. The water stop strips 80 are accommodated into channels 114 preset along the frame borders 111. Water stop covers 90 are disposed between the two short sides of the recess 11 and the side covers 20. The water stop covers 90 can completely seal the short sides of the recess 11. Accordingly, the inside of the recess 11 of the base 10 can form a complete enclosed space to achieve the function of preventing water drops or moisture from permeating.

The foregoing locking member sets 30 adopts a kind of screws and nuts according to a preferred embodiment of the present invention.

Although the features and advantages of the embodiments according to the preferred invention are disclosed, it is not limited to the embodiments described above, but encompasses any and all modifications and changes within the spirit and scope of the following claims.

What is claimed is:

1. A lamp holder structure having heat dissipation fins comprising: a long strip base of which one end comprises a recess showing passing through state along a long side, the recess forming symmetric frame borders along the long side, a corresponding external surface of the recess having a plurality of heat dissipation fins integrated and extended and arranged in parallel, the characterized in that: a portion of the heat dissipation fins of the base having a plurality of heat dissipation diverging fins that is integrated and extended.

2. The lamp holder structure having heat dissipation fins as claimed in claim 1, wherein a corresponding surface of the recess comprises several threaded holes for installing a light emitting lamp set.

3. The lamp holder structure having heat dissipation fins as claimed in claim 1, wherein the corresponding surface of the recess comprises at least one power line-in, and the power line-in is fitted with a soft stop ring for connecting a power line having a waterproof connector.

4. The lamp holder structure having heat dissipation fins as claimed in claim 1, wherein two corresponding short sides of the base comprises a plurality of locking holes, and a portion of the locking holes is distributed and connected to the heat dissipation fins for locking symmetric side covers.

5. The lamp holder structure having heat dissipation fins as claimed in claim 1, wherein the base is an aluminum extrusion base made of a heat conduction material.

6. The lamp holder structure having heat dissipation fins as claimed in claim 1, wherein the base comprises symmetric circular holes spaced at an interval of the recess, and grooves corresponding to the circular holes are cut and formed from a portion of the heat dissipation fins, and a plurality of locking members is incorporated to connect symmetric protruding plates, and another end of the protruding plate has an axle hole and a limiting hole.

7. The lamp holder structure having heat dissipation fins as claimed in claim 6, wherein the two protruding plates are connected to a positioning plate through shaft holes of the protruding plates, and the positioning plate comprises symmetric side plates, and the two side plates comprise alignment shaft holes corresponding to the axle holes of the protruding plates, and a plurality of limited holes is distributed to a periphery of the alignment shaft holes of the side plates, and corresponds to the limiting holes of the protruding plates.

8. The lamp holder structure having heat dissipation fins as claimed in claim 1, wherein the two side covers comprise a plurality of through holes corresponding to the plurality of locking holes of the short sides of the base, and a plurality of screws is locked into the through holes.

9. The lamp holder structure having heat dissipation fins as claimed in claim 8, wherein a water stop covers is disposed between the side covers and the two corresponding short sides, and the water stop cover completely seals the short sides of the recess.

10. The lamp holder structure having heat dissipation fins as claimed in claim 1, wherein the base at fronts of the two frame borders comprises a plurality of connection holes, a light-transmissive plate for sealing the recess of the base; and two side strips having a plurality of locking holes incorporated with a plurality of screws to lock and to connect the connection holes of the frame borders, and for leaning against the light-transmissive plate.

11. The lamp holder structure having heat dissipation fins as claimed in claim 10, wherein corresponding exteriors of the two frame borders of the base comprise symmetric fastening notches, and fastening portions for aligning the fastening notches are integrated and extended from the two side strips corresponding to corresponding sides of the fastening notches.

12. The lamp holder structure having heat dissipation fins as claimed in claim 10, wherein the base respectively comprises a water stop strip disposed between the two frame borders and the light-transmissive plate, and the base presets channels along the frame borders to fit and to limit the water stop strips.
